(19) United States
(12) Patent Application Publication
(10) Pub. No.: US 2006/0106605 A1
(43) Pub. Date: May 18, 2006

(54) Biometric record management

(76) Inventors: Joseph M. Saunders, Vienna, VA (US); Nigel A. Elkan, Great Falls, VA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/986,056

(22) Filed: Nov. 12, 2004

(51) Int. Cl. G10L 17/00

(52) U.S. Cl. 704/246

(57) ABSTRACT

A method of enrolling voice information of an individual in a repository is disclosed. The individual may be associated with a contributing entity and the repository may be used by multiple entities within a consortium for creating, accessing or enhancing one or more forms of utterances associated with an individual. The method comprises establishing a predefined certification process for enrollment by multiple contributing entities of individual voice information in a repository, capturing one or more utterances from an individual associated with a contributing entity while the individual communicates over a network and storing one or more forms of the captured utterance associated with the individual along with information identifying the contributing entity associated with the individual in the repository.

### FIELD OF THE INVENTION

The present invention relates generally to biometric authentication, and more particularly to methods of managing biometric records for use in real-time applications.

### BACKGROUND AND SUMMARY

Generally speaking, biometric authentication is the use of specific characteristics that are unique to an individual as a means to verify the identity of the individual. This unique verification typically requires at least two steps: the capture of an utterance or other biometric data, and an authentication process whereby the characteristics of an individual's captured utterance are compared to pre-stored voice information. Biometric solutions measure the degree of similarity, or goodness of fit, between a captured utterance or candidate biometric (such as voice data captured from a caller as part of a transaction over the telephone) and a stored utterance within a biometric record. The result, which is typically delivered as a score, is used to determine the quality of the match and thus the likelihood that the individual submitting the candidate biometric is the individual with the enrolled biometric record.

Biometric solutions have been used traditionally in “silos,” specific high security environments and in government applications, such as terrorist or other criminal activity analyses. As these technologies are becoming easier to implement and more highly available, biometric solutions are becoming popular as a means to combine convenience and security. They are convenient because an individual can be verified or authenticated using physical characteristics rather than memorized data, and they are secure because the characteristics of an individual's biometric are unique to that particular individual and cannot be reverse engineered. As a result, there is a substantial growth in the applicability of biometric solutions.

Because biometric authentication capabilities are not fully integrated into the transaction systems of most business organizations or entities, the features and advantages that biometric authentication is capable of providing are not yet maximized. As biometric solutions increase in popularity and become more widely available, there will be heightened interest in combining efforts between different and potentially competing organizations or entities, as well as competing operations within the same organizations, to manage a certified process of biometric enrollment and authentication. These entities can cooperate to raise the quality of the overall biometric solutions, to distribute the expenses associated with the collection or enrollment of the reference voice information, and to increase consumer confidence as to the value and effectiveness of using biometrics to secure and accelerate access to protected data.

Accordingly, improved systems and methods to better raise the quality, distribute the cost, and take advantage of biometric authentication capabilities for various uses such as to provide improved security and fraud protection for businesses and to increase consumer confidence in voice transactions would be advantageous.

The opportunity exists for creating a series of national or even international certified biometric repositories by enabling multiple entities to enroll and update individuals' biometric records in the repositories using standardized certification procedures. Making queries to the repositories to retrieve certified reference records for the purpose of verifying an individual's identity can become a key component in preventing fraud and building consumer confidence in the utilization of biometrics as a means to secure transactions. Embodiments according to the inventions disclosed herein can accommodate a wide spectrum of entities may find value in a biometric solution that manages the lifecycle of certified biometric records. These entities may cooperate in forming a “consortium” for the purpose of sharing current biometric data of individuals who conduct business with any entity within the consortium. The biometric reference records in the repositories of the member entities evolve through repeated verification or authentication attempts by individuals who contact the entities to conduct business transactions. Each time an authentication attempt results in a captured utterance and/or candidate biometric that is somehow different or better than one or more forms of utterances already contained within the individual's reference biometric record, the instance is stored to enhance the reference record, and in this way the individual's biometric record is maintained as current within the repositories throughout the consortium.

Just as importantly, embodiments of the inventions can deny fraudsters (i.e. individuals or entities engaged in fraudulent activity) the opportunity to perpetuate crime. Because of the unique quality of voice information, gaining access to confidential data or conducting other such transactions between an individual and an entity requires a high level of likeness between the individual's captured utterance and/or candidate biometric and reference biometric data enrolled in a repository. Not only would attempts to penetrate the system result in the fraudsters leaving behind their unique biometrics and therefore make them vulnerable to identification, but because fraudsters are populating a central, distributed, or otherwise shared network of repositories, it would become especially easy and convenient to share data associated with attempted frauds with the members of the consortium as well as third party entities.

Management of certified enrollment and authentication processes enables a contributing entity within the consortium to enroll an individual's utterance and/or biometric data and provides the ability for a second entity to use the voice information so enrolled for authentication purposes within its business while continuing to satisfy the security criteria of other consortium entities. The standard is defined so as to enable each member entity to ensure that the security standards in force within that entity are maintained. That is, a standardized certification process for enrollment and authentication of biometric data, including for example utterances and voiceprint records, is established whereby biometric records enrolled by one entity can be accepted as certified reference records which may be incorporated into a second entity's application. The acceptance of a certification standard and the opportunity to integrate such data into business or other applications establishes the framework for a biometric marketplace, whereby the first entity to enroll an individual's biometric may present the reference record to other entities for authentication purposes, or a second entity may update or enhance an individual's reference record by appending additional biometric data to a previously enrolled biometric record, such that the stored reference record evolves. In such a marketplace, a fee may be paid to the first entity to enroll an individual's biometric, the entity that updates or enhances the stored reference record, the manager of the centralized, distributed, or otherwise shared network of repositories, or any entity that makes the reference records available to a third party.

Creating a biometric marketplace by enrolling, authenticating, and managing certified biometric records in a shared network of repositories within a consortium is beneficial to both businesses and consumers who wish to conduct secure transactions and access protected data via communications networks. Because of the unique nature of biometric data, aggregating biometric data from multiple members of the consortium using a standardized certification process for collection and enrollment, then permitting access to the data through a carefully managed method of authentication, substantially eliminates concerns about fraud and streamlines secure access to protected data, while maintaining safeguards to protect the data and alleviate consumer privacy concerns. Therefore, it is useful to provide a method of managing the lifecycles of individuals' biometric records for a large population by combining the efforts of multiple entities using a standardized certification process for enrollment and authentication of the biometric records.

According to an embodiment of the inventive technology disclosed herein, a method for managing the lifecycle of a biometric record is provided that includes enrolling biometric data from an individual using a communications device over a communications network. When an individual contacts a member entity of the consortium, the entity's IVR interacts with its customer database to determine if a record for the individual exists. If a customer record exists, the entity then sends a query to a repository of certified biometric records to determine if the individual has enrolled utterances and/or biometric data in the repository. If no reference record exists, the individual is invited to enroll an utterance and/or biometric data in the repository. If the individual chooses to enroll data, the individual's utterance information is captured through means of a standardized enrollment process using a voice network interface, including traditional voice recognition software coupled with touchtone solutions, Internet applications, or other biometric-secured applications.

A preferred embodiment of a biometric-secured application includes capturing an individual's utterance after the individual receives an indication that it is safe to proceed with providing utterance information. That is, before the individual is prompted to speak a sample utterance, the individual receives an indication characterized by a sensory experience—an audible, visible, or other media-appropriate sensory image, such as an express communication or a characteristic tone—notifying the individual that he or she has entered a “secure zone” and that the network connection is adequately secure for conducting business or for conducting a dialogue. This sensory experience is substantially similar and is designed to be easily recognizable each time the individual attempts to conduct a transaction requiring utterance information.

The utterance information is stored as a certified biometric record in a centralized or distributed repository or network of repositories. The certified enrollment process uses a standard set of rules that enables enrollment by one or more entities within the consortium and defines security parameters for enabling or preventing access to reference records in the repository. A network interface provides access to the repository for the purpose of contributing to, retrieving, or updating enrolled utterances and/or biometric data contained within the repository such that the integrity of each certified biometric record is maintained as current.

The enrollment process enables utterances and/or biometric data enrolled by one member of the consortium to be certified as accredited and deployed within any other member entity's application. An entity that first enrolls an individual's certified reference record may allow access to such record to other member entities or third parties to verify or authenticate an individual's identity through a candidate biometric or to subsequently update or enhance the reference record of the individual. Under certain circumstances, where a third-party member of the consortium is an accepted enroller of biometric data and where the individual has satisfied defined enrollment criteria, the third-party entity may append additional biometric data to the certified reference record created by the entity that first enrolled the individual's biometric data, thus enhancing the individual's reference record. An entity that first enrolls the biometric data of an individual as a certified reference record may charge a fee to an entity that subsequently accesses the certified biometric reference record for authentication or modification purposes. Similarly, an entity that updates or enhances a certified reference record may charge a fee to an entity that subsequently accesses the record for authentication purposes.

According to another embodiment of the inventive technology, a method for managing a biometric lifecycle is provided that includes authenticating captured utterances and/or biometric data of an individual using a communications device over a communications network. An individual's identity is verified through authentication of the individual's biometric by comparing a captured utterance or candidate biometric, derived from a caller over a telephone network, for example, with a certified reference record enrolled in the repository. If a reference record for an individual exists, the individual's utterance information is captured for authentication purposes within a “secure zone,” a characteristic sensory experience as described above. An instance of the individual's biometric is created each time the individual makes an attempt to access a service that uses an authentication application. Utterances or candidate biometrics are captured and aggregated selectively or entirely, in order to update or otherwise enhance the individual's certified reference record in the repository.

The authentication application is configured with predefined authentication criteria to identify the reference record that corresponds with the individual's utterance and/or biometric information captured over a network connection of a specific quality. That is, the captured utterances and/or candidate biometrics may vary depending on the type of communications device the individual is using; therefore, an ideal reference record would contain stored utterances and/or biometric data for each type of device. Each certified biometric record contains an identifier for the individual separate from the biometric, such as a telephone number or other personal or household identifier, which is used in conjunction with the captured utterance or candidate biometric to determine if the individual corresponds to a reference record in the repository. In addition, attributes can be appended to each reference record to identify the particular contributing entity and the quality of the utterance information and/or biometric data for each stored instance in the record.

The authentication application generates a score based on the quality of the match between the captured utterance or candidate biometric and one or more forms of a stored utterance and/or biometric data contained in the reference record. The calculated score acts as a basis for controlling the individual's access to a service. If necessary, additional challenges to the individual may be posed to supplement the calculated score. An individual who is issued a score below a threshold is restricted from at least one service or transferred to a live handling agent, while an individual who is issued a score beyond a threshold is transferred to the service that the individual desires to access. An individual who is issued a score below a threshold and whose identity is subsequently verified or authenticated through adequate responses to additional challenges or by a handling agent may be required to re-enroll an utterance and/or biometric data in the repository. The individual's score is appended to the reference record upon each authentication attempt and is used in subsequent transactions involving voice information related to the individual.

A suspicion level is assigned based on the generated score, and a list of suspicious or fraudulent individuals is created based on unsuccessful authentication attempts (i.e., stored utterances that do not correspond with the individuals' claimed identities) or the repeated issuance of low scores to a particular individual. The list, along with utterances and/or biometric data of suspicious individuals, may be made available to members of the consortium or third parties for independent investigation.

According to another embodiment of the present invention, a method for managing the lifecycle of a biometric record is provided that includes managing all of the records within the repository according to a defined certification process. One entity manages the certification process for the collection, storage, and distribution of voice information as certified reference records from a centralized or distributed repository or network of repositories. The manager ensures that captured utterances and/or biometric data is enrolled in a fashion that complies with a defined standard and that any evolution, enhancement, or other adaptation to the record continues to comply with the standard. The manager provides an interface that enables members of the consortium to update or enhance biometric data that they have previously enrolled in the repository.

In this way, an individual's certified reference record evolves during its lifecycle through subsequent adaptations and enhancements each time the individual makes an authentication attempt. In addition, the manager maintains the directory or directories of certified reference records, the rules for accessing reference records, the adaptation or evolution rules and security standards for the records, member entities' compliance with the rules and standards, and the delivery of reference records for use, replication, back-up, or other legitimate purposes. The manager of the repository assigns access privileges to member entities and third parties based on whether a particular entity contributes utterances and/or biometric data to the repository or submits authentication requests for data retrieval from the repository.

Certified reference records are made available to the members of the consortium in real time. These biometric records are accessible from a centralized repository, a distributed repository, or from replica repositories local to each member entity. In addition, certified records are stored, either by member entities or by the manager, in an archive, back-up or roll-over repository, and changes to voice information contained in a reference record are synchronized such that a replica of the record is maintained in the back-up repository. Where such synchronization is not made in real time, the replica is queued such that the replication can be made as quickly as is practical, or in accordance with defined replication rules and timetables. In this way, certified reference records are available to any entity at any time, even if one of the repositories is not currently functioning. The biometric management function has the ability to offer access to certified records on a transaction basis for the purpose of enrollment or authentication of an individual's identity, or for providing a product or service related to the biometric data. The manager may charge a fee, for example, a management fee, transaction fee, or other such charge, in exchange for providing enrollment, authentication, or management services.

### BRIEF DESCRIPTION OF THE DRAWINGS

The invention can be more fully understood from consideration of the following detailed description of illustrative embodiments of the invention and the accompanying drawings in which:

FIG. 1 is a block diagram representing the overall system for managing utterance and/or biometric data enrollment and authentication processes;

FIG. 2 is a flow diagram representing the method of utterance and/or biometric data enrollment for an individual;

FIG. 3 is a block diagram representing the lifecycle of a certified biometric record; and

FIGS. 4A and 4B are flow diagrams representing the overall method of biometric authentication.

### DETAILED DESCRIPTION OF THE PREFERRED EMBODIMENTS

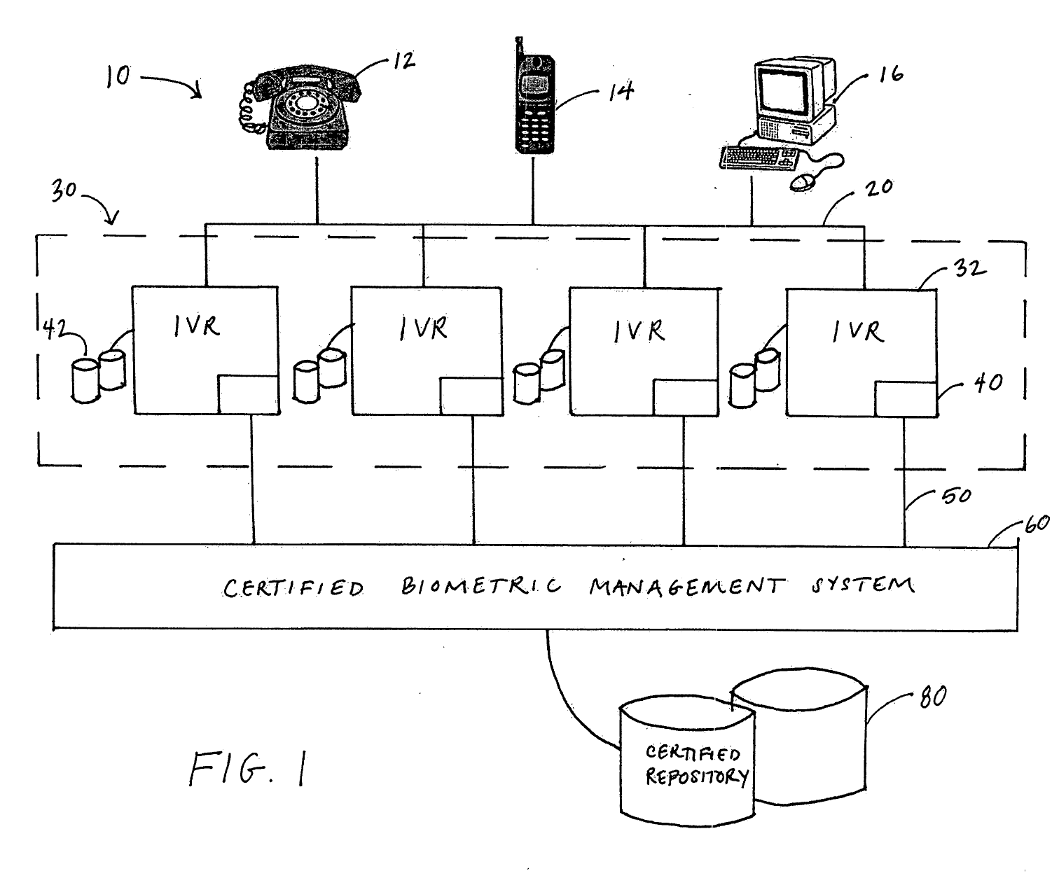

FIG. 1 is a block diagram illustrating an overall system for managing voice information enrollment and authentication processes. The system comprises a plurality of communications devices 10, a communications network 20, a consortium of participating entities 30; one or more interactive voice response (IVR) systems 32, a certified biometric management system 60, and a certified biometric repository 80. The communications devices 10 may comprise landline telephones (POTS lines) 12, wireless telephones 14, computer terminals configured for VoIP or some other form of multimodal device 16, or any other suitable communications devices. The communications network 20 is operable to establish communication sessions between the users of the devices and the IVRs 32 of members of the consortium 30. A member entity of the consortium 30 can comprise one or more businesses within the same business organization or within different business organizations. Exemplary member entities 30 are credit card companies and financial institutions, although virtually any type of organization could be an entity. Each IVR 32 within the consortium 30 has a biometric management client software module 40 that links the IVR 32 and the database of customer records stored in the local repository 42 of the consortium member 30 to the certified biometric management system 60 and enables the retrieval of records from the certified biometric repository 80.

The communications network 20 is also operable to provide call data that identifies the type of communications device 10, the biometric data of the individual using the device, and the like, to the certified biometric management system 60 for processing and to receive information from the system 60 for use in managing communication with the devices 10. The biometric data comprises biometrics such as voiceprints or audio files that contain digital representations of voiceprints. The certified biometric management system 60 works in conjunction with a repository 80 that contains certified biometric records. While FIG. 1 shows a repository 80 as single logical repository, repository 80 can be a centralized or distributed repository. Moreover, biometric records can be stored in and accessed from both repository 80 as well as in one or more repositories 42 maintained by members of consortium (and repositories 42 can themselves be centralized or distributed).

For example, a customer desiring to access account information over the telephone may call a bank to request the information via the bank's IVR. The IVR interacts with the bank's database of customer records to determine if a record exists that is associated with the caller's name and/or telephone number. If such a record does exist, the IVR determines if stored voice information exists for the individual in a centralized or distributed repository of certified biometric records. If a biometric record does exist, the caller is asked to respond to a number of challenges, and the responses are compared to the pre-stored utterances. If the quality of match between the captured utterance, or candidate biometric, and the pre-stored utterances in the record is sufficiently high, the individual is able to complete the transaction. If the match is not sufficiently high, the individual's desired transaction can be denied or handled independently such as through a live call-handling agent.

The certified biometric management system 60 may be coupled to the communications network 20 locally at the consortium member sites 30 or may be remote from the communications network 20 and coupled to the communications network 20 through communications lines or other suitable networks 50. As described in more detail below, the certified biometric management system 60 operates by storing captured utterances and/or biometric data from individuals using communications devices 10 and comparing the data with biometric records stored in a repository 80 of certified biometric records. While the preferred system stores reference utterances and/or biometric data in the repository 80, as discussed in more detail below, alternative embodiments can store certified reference records in distributed repositories that are coupled to one or more of the consortium members 32. Also, while the preferred biometric is a voiceprint, adaptations of this system can apply to any other type of biometric, such as using a scanning device to read fingerprints, perform retinal or iris scans, or the like.

As mentioned above, the certified biometric repository 80 can be centralized or distributed across multiple databases that are connected to the certified biometric management system 60. One way to achieve a distributed repository is for each member of the consortium 30 to house a portion of the overall repository—that is, the portion that contains its own customer records—with links created between the multiple repositories 42 and the certified biometric management system 60. In this way, each member of consortium 30 can access biometric records for its own customers from its local repository 42 while providing other members distributed access. This will permit each consortium member an increased level of control over its customer records, and can facilitate controlling access for purposes such as security or charging fees for access. Thus, for example, a consortium member can disallow others from modifying some of its customer information while charging a fee for read-only access.

Another alternative for a distributed biometric database is for each consortium member 30 to locally house an exact replica of the overall repository, in which case biometric management system 60 can facilitate maintaining currency (i.e. keeping current) of the distributed repositories 42 by interfacing with each consortium member through biometric client management module 40. Regardless of whether the repository is centralized or remote 80, the biometric management client software module 40 for each member of the consortium 30 will determine whether the IVR 32 retrieves biometric information from the local repository 42 or queries the certified biometric repository 80 across a network connection 50. The network 50 can be separate from or part of the communications network 20.

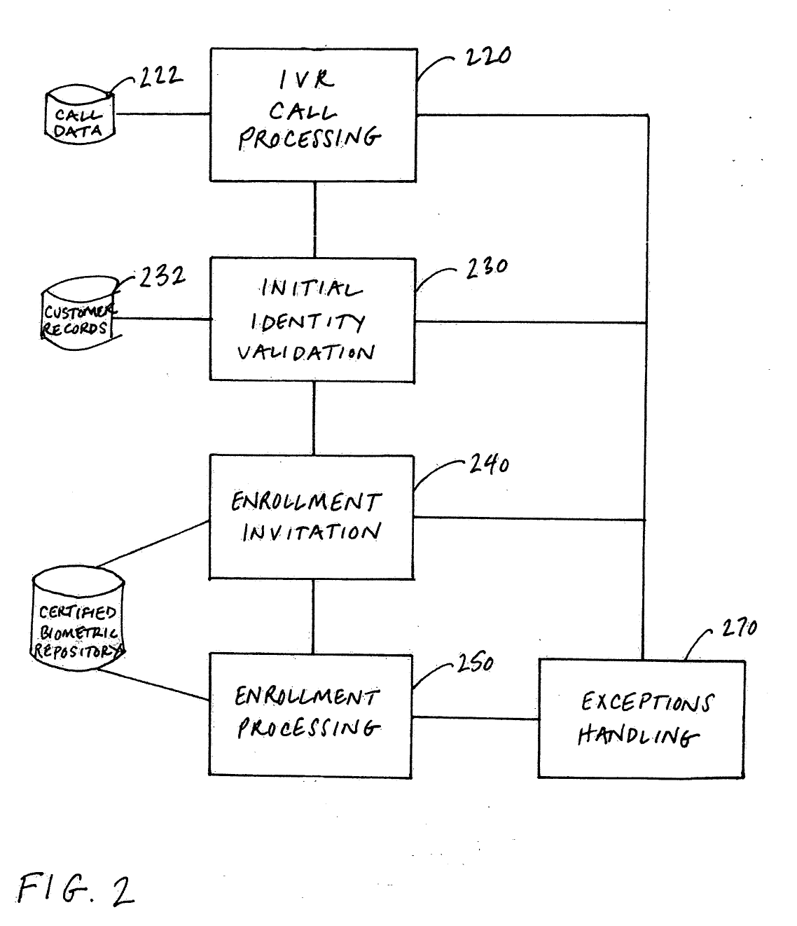

FIG. 2 is a block diagram illustrating processing stages (or phases) and data used in a method of enrollment of voice information for an individual using a device 12, 14, 16 to communicate with an IVR 32 over a communications network 20 from FIG. 1. In the first phase 220 the IVR 32 processes the call to establish the communication session and collect information that might be provided automatically from the network, such as the type of device or the Automatic Number Identification (ANI) for a POTS telephone call. Once communication commences between the individual and the IVR 32, call data 222 such as the ANI, IP address, type of device, and type and quality of the channel (as determined by the amount of in-line or off-line noise) is collected from the individual for processing purposes.

In an exemplary embodiment, the entity's IVR 32 performs an initial verification (or validation) of the individual's identity in phase 230 based on an expressed or derived identification claim, such as matching an identifier associated with the communications device the individual is using (e.g., ANI from a POTS telephone line or an IP address from an Internet device) or some other form of identification challenge. The IVR 32 then searches a database of its customer records 232 for information that matches the call data 222 that has been collected. While FIG. 2 shows an example of retrieving data from a single database, other more sophisticated mechanisms for obtaining information that matches the call data 222 is contemplated, such as data linkage technology as described in U.S. Pat. Nos. 5,901,214 and 6,748,426, which are hereby incorporated by reference.

For voice communication over a telephone, the preferred identifier is the caller's telephone number, which can be captured in various ways, such as through the use of the ANI, or through keypad or voice input from the caller. If the individual is not identified as an existing customer, the call is transferred to an exceptions handling process 270 such as a live handling agent for independent processing.

If the call data 222 matches a customer record 232 (i.e., the customer is identified as an existing customer), the process proceeds to an enrollment invitation phase 240. The IVR 32 sends a query to search the repository of certified biometric records 252 to determine if a certified record associated with the individual exists. If there is no reference record associated with the call data 222, then the individual is invited to enroll an utterance and/or biometric data during phase 240. Enrollment proceeds when the individual confirms that he or she would like to enroll a biometric record in the repository. If the individual chooses to enroll, the communication session enters an enrollment phase 250, using such methods of enrolling voice information as are well known to those of ordinary skill.

If during phase 240 the individual declines the invitation to enroll an utterance and/or biometric data, or if there is some concern based on the data (e.g., the device is excluded from satisfying the enrollment criteria—as in a prison payphone, or there is a suspicious connection with a large amount of noise on the line), then the call is transferred to an exceptions handling process 270.

If during phase 240 the individual decides to enroll an utterance and/or biometric data in the repository 252 and the enrollment is successful, then the individual's biometric record is flagged as “provisionally certified.” The individual is then able to proceed with a desired transaction.

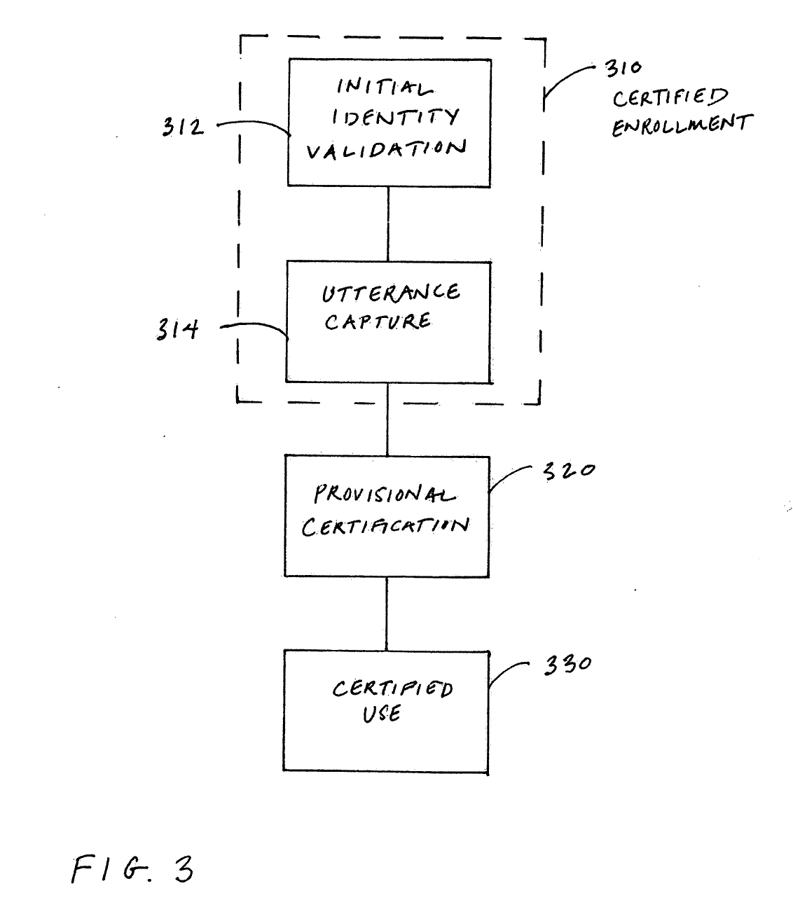

FIG. 3 is a block diagram illustrating the phases of the lifecycle of a certified biometric record containing reference voice information (such as a voiceprint) within a biometric management system 60 from FIG. 1. The certified biometric management process uses a defined set of rules that enables enrollment and subsequent enhancement by multiple contributing entities within a consortium. The lifecycle stages include: a certified enrollment process 310 (which comprises initial identity validation 312 and utterance capture 314), a provisional certification stage 330, and a certified use stage 340.

Each stage of the lifecycle implements a standard set of rules that allows the reference record to evolve through repeated authentication attempts during the course of the biometric lifecycle. Examples of such rules for the initial validation step 312 of the certified enrollment step 310 include identifying the type of communications device the individual is using (whether POTS, CDMA/TDMA or VoIP), capturing the ANI, and requesting additional tokens to verify the individual's identity claim. Examples of tokens are account number, social security number, and date of birth.

A result of certified enrollment 310 is the generation of an independent score based on the quality of the connection, the quality of the information, and hence the degree of likelihood that the individual is who he or she claims to be. The quality of the connection can be affected by such things as the type of device the individual is using, the geographic location of the call, and the amount of noise on the line. Examples of other factors that can affect the enrollment score are the ANI from which the individual is calling and the clarity of the individual's voice (e.g., whether the individual's voice happens to be compromised due to illness). The enrollment score can indicate a raw confidence level in the authenticity of an enrollment. For example, the score can be higher for an enrollment of a name previously known to be associated with the ANI of the caller and lower for an enrollment when the ANI is blocked, is associated with a different name, or indicates the call comes from overseas. The enrollment score is independent of previously enrolled voice information whereas a score generated during an authentication can use the result of comparing captured utterance information with the previously enrolled voice information.

Exemplary rules for the utterance capture step 314 of the enrollment process 310 include capturing sample utterances by requesting the individual to speak predefined numbers, words and/or responses to challenges. For example, the individual may be requested to speak the first ten letters of the alphabet, the numbers one through ten, and a variety of short sentences or phrases. The individual's utterances are captured, and the sample utterances or biometric data or both are stored as a record in the repository. Both the individual and the consortium members are uniquely identified within the certified enrollment process 310, and the enrollment process 310 is configured to allow multiple enrollments of a single individual by multiple member entities.

If the individual completes the certified enrollment 310 process successfully, the outcome is that the individual's record enters the provisional certification phase 320. An exemplary provisional certification phase 320 is a probationary period, such as a 90-day confirmation period in which, for example, any identification claim that meets an eighty (80) percent likelihood that the individual is who he or she claims to be will be satisfactory. An individual with a satisfactory identity claim is able to proceed with the transaction in accordance with the appropriate security grant.

During the provisional certification phase 320, an individual who did not request a secure transaction or who failed to create a satisfactory identity claim may complete the transaction using an IVR solution or agent handling process as appropriate. During the provisional certification period 320 transactions are flagged as provisionally certified and monitored; consortium members are alerted to anomalies and other suspicious activity. For example, large initial purchases, requests for multiple new credit cards, concurrent purchases in different geographic regions, and peaks of purchasing behavior are scrutinized. The rules also provide for temporary suspension of privileges in the event of suspicious behavior.

In order for a biometric record to be certified during the provisional certification period 320, it must meet defined certification standards. An individual is called an enrollee after the individual's biometric record becomes provisionally certified. An enrolling entity is a consortium member that enrolls an individual's biometric record in the repository; an original enrolling entity is the consortium member that first does so. Exemplary certification standards may include, for example, prior to an individual's biometric record becoming provisionally certified, an entity may be required to receive confirmation from an enrolling entity that the individual is indeed an account holder of the enrolling entity and that the account is valid (i.e., not suspicious or fraudulent).

Another certification standard may mandate that, based on data verifications by various consortium members, no suspicious activity is associated with the individual or account. Examples of such data verification may include: a match between the address on file with one or more consortium members and a trusted third party source, confirmation that all attempted enrollments by consortium members for the same unique identity sufficiently match the original enrolling entity's reference record, a determination that biometric match scores during identity claim phases of the authentication process are similar to those originally generated for the individual during the enrollment process, and verification that suspicion of fraud does not exist on any account related to the individual (e.g., verification that no credit cards have been reported stolen for the individual within the probationary period).

Once the provisional certification period 320 is successfully completed, the individual's biometric record becomes fully certified or confirmed and the biometric lifecycle progresses to a certified use phase 330. In this phase of the lifecycle, through repeated use of the certification process, an individual achieves an enhanced reference biometric record. Successful identity claims during this period may need to meet a threshold that is lower than during the provisional certification stage 320 because of the increased ability to verify that the individual is who he or she claims to be (e.g., because of a greater number of stored utterances and/or because of a greater confidence in the pattern of transactions). During this phase, all transactions are flagged as certified, and consortium members are alerted to anomalies and other suspicious activity.

Additional biometric data associated with the individual may be appended to the reference record to refine the individual's certified biometric record. The certified biometric management system 60 provides an interface that enables members of the consortium to update or enhance biometric data that they have previously enrolled in the certified repository. If a captured utterance is a close match to a previously stored utterance in the reference record, the quality of that individual's reference record may be enhanced through a process of adaptation or “record evolution.”

Stored voice information can evolve either by augmenting the reference record with biometric data from a subsequently captured utterance, replacing the previously stored utterance with the subsequent utterance, or maintaining alternative instances of the stored utterance in accordance with the specific parameters of the reference record. For example, stored voice information with a poor initial quality of connection may be replaced by a subsequently captured utterance and/or biometric data with a higher quality of connection. Similarly, a reference record may contain initial biometric data that corresponds with the individual using different types of network connections, such as separate stored utterances that correspond with the individual using a POTS line as opposed to the individual using various types of wireless connections.

Additionally, a certified reference record may be improved by appending biometric instances each time an individual is requested to respond to additional speech or knowledge challenges, as described in more detail below. A network provides access to the repository for the purpose of contributing to, retrieving, updating, or enhancing reference records in the repository such that the integrity of each certified record is maintained as current.

Throughout both the provisional certification stage 320 and the certified use stage 330, an audit process is used to track transactions that access an individual's certified reference record. Different audit rules apply during the different phases of the biometric lifecycle. For example, during the certified use phase 330, after 270 days of inactivity, repeated poor matches on authentication attempts using the appropriate threshold level for acceptance, or multiple incidents of failed authentication attempts, re-enrollment of voice information may be required. Under such circumstances, the rules may mandate temporary suspension of privileges in the event of suspicious behavior until the individual is able to re-enroll utterance information via the standard certification process. One of ordinary skill can apply myriad rules to effect the desired level of risk management during the various lifecycle phases.

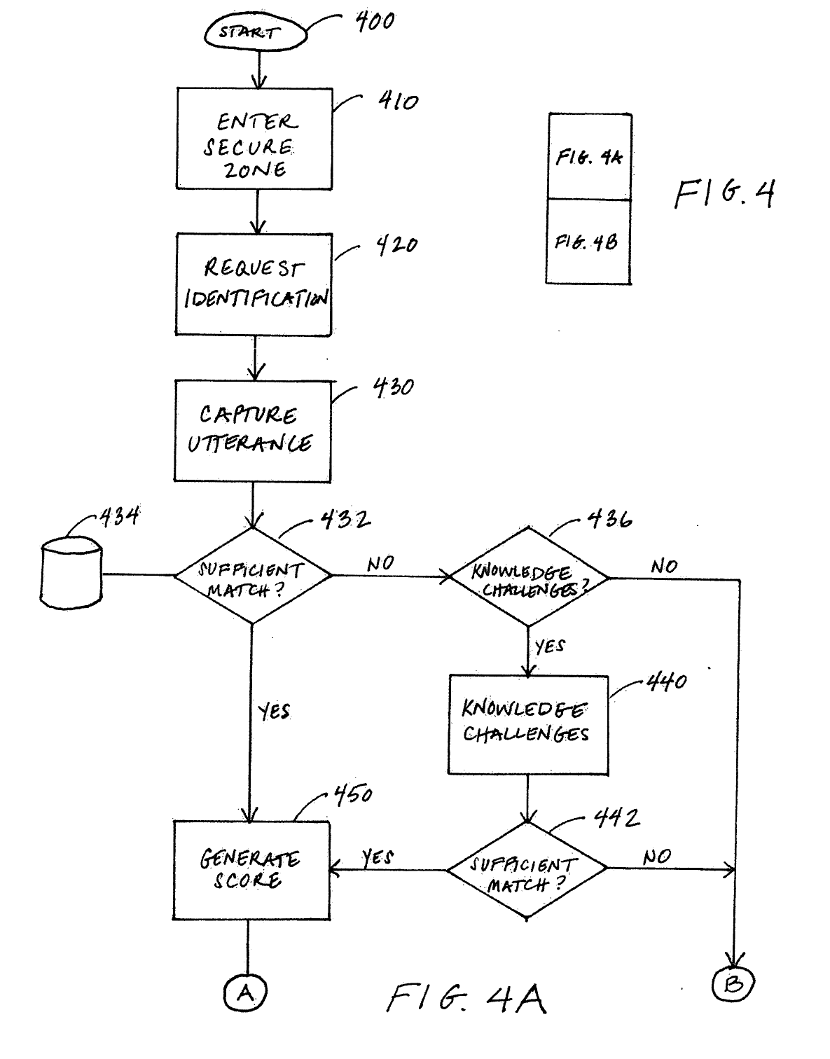

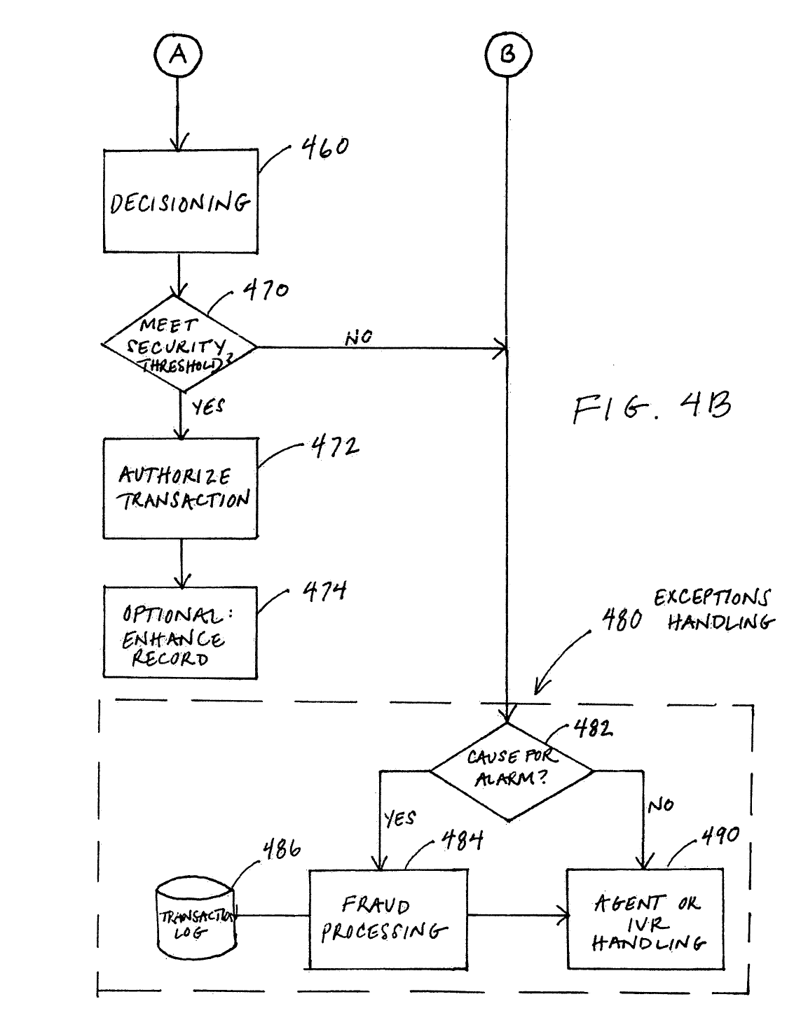

The flow diagrams of FIGS. 4A and 4B illustrate an exemplary method of authentication. First, an individual on a communications device connects with an IVR of an entity within the consortium. After the individual makes an initial identity claim (i.e., speaks his or her name) 230 from FIG. 2, the IVR determines if reference voice information exists for the individual. If a stored reference utterance does exist, the individual is alerted that he or she is entering a “secure zone” at step 410.

The communication of entry into the secure zone is accomplished through a sensory experience, such as audibly through express dialogue or a characteristic tone, or a by a visual experience, to indicate that it is safe to continue with the transaction. Through repeated use, the sensory experience used to indicate entry into the secure zone will become familiar to the user.

Within the secure zone, the individual is requested to make an identification claim at step 420. For example, the individual is requested to speak his or her name or account number. Alternatively, an identifier such as ANI, an IP address, or information stored on the communicating device, can be captured automatically and then used in conjunction with captured utterance information. In another alternative the individual may be asked to provide additional information through speech challenges (which can mitigate the risk of use of pre-recorded utterances by fraudsters). For example, the individual may be requested to speak “red fox” or “1, 2, 3, 4, 5.” The individual's utterance is captured and a derived biometric is generated at step 430.

At decision point 432 the authentication application compares the captured utterance and/or derived biometric to the reference voice information that is stored in the repository 434. The authentication application is also configured to determine unique identifiers of the individual separate from the biometric and to use the identifiers, in addition to the derived biometric, to determine if the individual corresponds to a record in the repository. The identifiers may include evidence of the individual's identity from a variety of sources ranging from internal and proprietary data sources, third party sources and other data which may be available either from within the public domain or from private or proprietary databases. Such other data may include, for example, a name or address associated with a telephone number, recent changes to the account or household, other enrollment attempts by an individual with the same claimed identity, other enrollment attempts from the same telephone number, known fraud or fraudulent attempts from the same address or from the same telephone number. Basically, the process contemplates use of other data as necessary or available in order to affirm or deny the likelihood that the individual making the identity claim matches the individual with the enrolled voice information.

If the utterance and/or derived biometric provides a sufficient match at decision point 432 to the voice information stored in the repository 434, the individual proceeds through the remainder of the authentication process. If the candidate biometric does not sufficiently match the reference information, then at decision point 436 there is a determination made based on the available information as to whether the individual should be presented with optional knowledge challenges or else transferred to an exceptions handling process 480. Depending on the quality of the match, the individual may receive knowledge-based challenges; if the quality of the communications line is sufficiently poor or there are indications of a high degree of risk of fraud, then the individual may be transferred to an exceptions handling procedure.

Knowledge challenges may include identifying data such as telephone number, address, social security number, date of birth, city of birth, or other such “knowledge” questions as may help affirm the identity of the individual. This data may also be combined with other biometric data, such as fingerprints, retina scans, or other data that is closely associated with the individual. If the responses to the optional challenges at step 440 provide sufficient corroboration to identify the individual at decision point 442 then the individual proceeds through the remainder of the authentication process. Depending on the quality of the match from either or both of steps 430 and 440 at decision points 436 and 442, the individual can be transferred to an exceptions handling procedure 480 for further processing for purposes such as fraud processing 484 or handling by a live agent 490.

The results of the information derived from the captured utterances and optional additional challenges are used to generate a raw score at step 450. The score is evaluated using a “decisioning tool” at step 460 which determines whether the identity claim, along with associated optional challenges, meets a certain security threshold based on the data comparison. If the claimed identity meets or exceeds a threshold level at decision point 470, the transaction is authorized at step 472 and the individual gains access to the data to the permitted security level. If the score is sufficiently high, and there is additional qualifying data sufficient to meet the enrollment criteria defined within the enrollment standards, the captured utterances and/or derived biometric may be stored in the repository 434 to enhance the quality of the individual's reference record at step 474.

If the claimed identity fails to meet the threshold level at decision point 470 or if the need for exceptions handling was identified at the earlier decision points 436 or 442, then the individual is transferred to an exceptions handling procedure 480. First a determination is made as to whether there is cause for alarm at decision point 482. In other words, in the event of a sufficiently low score from decision points 436, 442 or 470, the authentication application searches for anomalies in the data or other causes for alarm. Such causes for alarm may include a prior enrollment of the same individual that does not match the current enrollment, a mismatch between the address corresponding with the telephone number and the address for the account on file, concurrent authentication attempts from different geographic locations, the individual using a communications device that is excluded from satisfying enrollment criteria (for example, a prison payphone), or an otherwise suspicious connection with an unusual amount of noise on the line. If there is no cause for alarm, the transaction may proceed with the individual being restricted from accessing confidential or otherwise secure data, or the transaction may be processed by a handling agent or an IVR at step 490.

If sufficient cause for alarm exists at decision point 482, the individual is transferred for fraud processing at step 484, which can be conducted through a handling agent or an IVR. During this step, the individual's identity claim (i.e., assumed name), along with the captured utterances and/or derived biometric data is flagged and compiled in a database of suspicious individuals 486. A list of these individuals, a transaction log associated with the individuals, or other data from the database may be made available to entities within the consortium. Such a flagged individual subsequently may have to pass rigorous criteria to certify his or her reference voice information or to gain access to data protected by the certification process. Each entity's fraud department has the option of investigating the fraudulent transactions independently.

Alternatively or in addition, as part of the fraud processing step 484, the individual can be transferred to a handling agent at step 490, and the transaction is completed upon satisfactory verification of the individual's identity. Similar to the case of an individual initially identified for fraud processing but who subsequently is confirmed, an individual who is transferred to a live agent and then corroborated may be required to re-enroll utterance and/or biometric information using more stringent enrollment criteria.

Aspects of the above described embodiments can apply to applications for voice authentication and other biometric entry points such as call centers and on-line (Internet) or other real-time or near real-time transactions. In these types of applications the identifier associated with the transaction can be ascertained and then the stored utterance and/or biometric data is delivered to the target site in real-time or near real-time. In a call center application, for example, knowledge of the caller's telephone number may automatically trigger a query for all biometric records that are associated with a given telephone number. Based on further information obtained as part of the transaction, an additional query may be made to further reduce the set of biometric records that may be candidate biometrics to match the caller. In such an architecture, the incoming call may be answered by an agent, may be processed through the traditional speech recognition or touch tone solution, or may be processed through the biometric-secured application.

Technical advantages of various embodiments of the present invention include the ability to create a biometric marketplace whereby accredited biometric data that is enrolled by one entity may be employed within the overall authentication processes of another entity. By enabling multiple entities to enroll utterances and/or biometric data in the certified repository it becomes possible to enroll a substantial proportion of any given population. By aggregating records of utterances and/or biometric data from different business entities into a global repository or shared repositories and granting multiple entities access privileges to the same reference information associated with the same individual, the invention enables and encourages the opportunity for multiple entities to share and improve upon data associated with a given individual.

The certification and authentication processes according to the invention facilitate the maintenance of utterance and/or biometric data from enrollment and throughout its lifecycle. Aspects of the invention facilitate lifecycle management by adopting certain standards to which members of the consortium may subscribe, including consortium members that are granted privileges to enroll, update, or otherwise enhance the stored utterance and/or biometric data associated with a given individual and consortium members that are granted reading privileges only. Such standards mandate certain minimum assurances that the individual is who he or she claims to be, and these standards can evolve as new opportunities and possibilities for fraudulent activities arise. An easily accessible shared, centralized, or distributed repository of certified utterances and/or biometric data records, can reduce fraudulent activity associated with network transactions and streamline access to protected data. In addition, the increased access and use of the records containing stored utterances and/or biometric data, along with the ability of the records to evolve throughout their lifecycles, can serve to continually improve confidence levels as to the value and effectiveness associated with applications that employ the certified authentication process.

This invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. A method of enrolling voice information of an individual associated with a contributing entity in a repository for use by multiple entities within a consortium that create, access or enhance one or more forms of utterances associated with an individual, the method comprising:
establishing a predefined certification process for enrollment by multiple contributing entities of individual voice information in a repository;
capturing one or more utterances from an individual associated with a contributing entity while the individual communicates over a network; and
storing one or more forms of the captured utterance associated with the individual along with information identifying the contributing entity associated with the individual in the repository.

2. The method of claim 1, wherein the voice information comprises a form of a recorded utterance.

3. The method of claim 1, wherein the voice information comprises a form of a derived biometric.

4. The method of claim 1, wherein the voice information in various forms for an individual is stored in a single record.

5. The method of claim 1, wherein the voice information in various forms for an individual are stored in different records.

6. The method of claim 1, wherein the repository comprises a central repository.

7. The method of claim 1, wherein the repository comprises a distributed repository.

8. The method of claim 1, wherein the repository comprises a shared network of repositories including third-party repositories.

9. The method of claim 1, wherein the voice information is accessible from a contributing entity's private repository through the incorporation of the entity's private repository with the repository.

10. The method of claim 1, wherein one or more entities comprises multiple businesses within the same business organization.

11. The method of claim 1, wherein one or more entities comprises multiple businesses within different business organizations.

12. The method of claim 1, wherein utterances are captured over network connections including one or more of a wireline telephone connection, a wireless telephone connection, and an Internet connection.

13. The method of claim 1, wherein capturing an utterance comprises recording utterance information using a voice network interface including an Interactive Voice Response (IVR) system.

14. The method of claim 1, wherein capturing an utterance comprises recording utterance information during communication with a live operator.

15. The method of claim 1, wherein capturing an utterance occurs after the individual receives an indication that it is safe to proceed with providing utterance information.

16. The method of claim 15, wherein the indication comprises a sensory experience including one or more of:
an express communication that it is safe for the individual to proceed;
an audible tone indicating that it is safe to proceed; and
a visual image indicating that it is safe to proceed.

17. The method of claim 16, wherein the individual is provided a substantially similar sensory experience each time the individual attempts to conduct a transaction requiring utterance information.

18. The method of claim 16, wherein the sensory experience is designed to be easily recognizable to the individual as an indication that the network connection is adequately secure for conducting business or for conducting a dialogue.

19. The method of claim 1, wherein storing one or more forms of the captured utterance associated with the individual in a repository further comprises storing an identifier that identifies the enrolling entity associated with the individual.

20. The method of claim 1, wherein storing one or more forms of the captured utterance associated with the individual in a repository further comprises storing a unique identifier that identifies the individual independently of an enrolling entity.

21. The method of claim 20, wherein the unique identifier comprises one or more of the individual's name, date of birth, and social security number.

22. The method of claim 20, wherein the unique identifier is configured for use across repositories within a consortium of entities such that a record associated with an individual enrolled within any given repository is associated with the captured utterance of the individual in the repository.

23. The method of claim 22, wherein inconsistencies between data contained within the repository for an individual and any other record associated with the individual generates an alert that is issued to one or more entities within a consortium.

24. The method of claim 19, wherein the identifier for an enrolling entity comprises data that is unavailable to third-party entities that have access to the repository.

25. The method of claim 1, wherein the predefined certification process comprises a provisional enrollment and a certified enrollment following the provisional enrollment.

26. The method of claim 1, wherein the predefined certification process defines parameters for use in enabling access to an individual's voice information stored in the repository.

27. The method of claim 26, wherein the parameters are configured to accommodate the addition of new contributing entities associated with an enrolled individual.

28. The method of claim 26, wherein the parameters are configured to accommodate the creation of new accounts associated with an enrolled individual.

29. The method of claim 1, wherein the predefined certification process uses security standards for allowing an entity to contribute voice information to the repository.

30. The method of claim 1, wherein a contributing entity that agrees to follow the parameters associated with the certification process obtains the right to certify the enrollment of voice information associated with an individual.

31. The method of claim 1, wherein the predefined certification process monitors transactions involving stored voice information in the repository for the purpose of limiting access to a service.

32. The method of claim 31, wherein limits are set on transactions when suspicious activity involving an individual's stored voice information exists.

33. The method of claim 32, wherein limits are set on a suspicious individual's transactions automatically using predefined criteria.

34. The method of claim 32, wherein limits are set on a suspicious individual's transactions at the request of a member of the consortium.

35. The method of claim 32, wherein suspicious activity is reported to members of the consortium.

36. The method of claim 31, wherein an individual's access to a service is denied when transactions involving the individual's stored voice information are deemed suspicious.

37. The method of claim 31, wherein an individual's access to a service is denied when transactions involving the individual's stored voice information do not occur during a predefined period of time.

38. The method of claim 1, wherein the predefined certification process for enrollment is configured to allow multiple enrollments of an individual's voice information by multiple contributing entities.

39. The method of claim 38, wherein an individual's first captured utterance to meet defined certification criteria is used to create reference voice information.

40. The method of claim 39, wherein the reference voice information is used until it is enhanced or replaced by other voice information that meets the certification criteria.

41. The method of claim 39, wherein a contributing entity that enrolls an individual's reference voice information grants other entities access to the reference voice information for enrollment, enhancement, or authentication purposes.

42. The method of claim 41, wherein a contributing entity that enrolls or enhances an individual's reference voice information charges a fee to an entity that subsequently accesses the reference voice information for authentication purposes.

43. A method of authenticating identity of an individual by comparing an utterance of the individual with one or more forms of utterances previously stored in a repository provided by one or more entities within a consortium, the method comprising:
capturing a speech utterance and an identifier from an individual while the individual communicates over a network;
making an attribute form of the utterance captured from the individual;
retrieving one or more forms of a previously stored utterance for the individual from a repository containing stored utterances of individuals contributed by multiple consortium entities based at least in part on the captured identifier;
using an authentication application to determine if the captured utterance corresponds with a reference voice information stored in the repository; and
controlling access to a service based on quality of a match between a form of the captured utterance and one or more forms of reference voice information retrieved from the repository.

44. The method of claim 43, wherein an utterance is captured during one or more of a communication with a live operator, use of an IVR, speech recognition software, or Internet applications, or by using some combination thereof.

45. The method of claim 43, wherein capturing an utterance of an individual occurs after the individual receives an indication that it is safe to proceed with providing utterance information.

46. The method of claim 45, wherein the indication comprises a sensory experience including one or more of:
an express communication that it is safe for the individual to proceed;
an audible tone indicating that it is safe to proceed; and
a visual image indicating that it is safe to proceed.

47. The method of claim 46, wherein the individual is provided a substantially similar sensory experience each time the individual attempts to conduct a transaction requiring utterance information.

48. The method of claim 46, wherein the sensory experience is designed to be easily recognizable to the individual as an indication that the network connection is adequately secure for conducting business or for conducting a dialogue.

49. The method of claim 43, wherein multiple forms of an individual's utterance are used to enhance the individual's reference voice information stored in the repository.

50. The method of claim 43, wherein the reference voice information of an individual contains attributes that provide qualitative measures for captured utterances.

51. The method of claim 50, wherein the attributes include data on the type of network used, the quality of the connection, and other qualitative measures.

52. The method of claim 43, wherein the authentication application is configured to identify the reference voice information that corresponds with the utterance of an individual captured over a network connection of a specific quality.

53. The method of claim 43, wherein the authentication application incorporates a rollback process.

54. The method of claim 43, wherein the authentication application is configured to accept authentication requests on a transaction basis.

55. The method of claim 43, wherein the authentication application is configured to determine a unique identifier of the individual separate from the utterance.

56. The method of claim 55, wherein the identifier is caller-provided, e.g., spoken or DTMF input.

57. The method of claim 55, wherein the identifier is automatically captured, e.g., ANI.

58. The method of claim 55, wherein the identifier is used in addition to the captured utterance to determine if the individual corresponds with reference voice information.

59. The method of claim 55, wherein the identifier identifies an individual using internal and proprietary data sources, third party data sources, or other data sources that are available in the public domain.

60. The method of claim 59, wherein the data sources are weighted according to relative importance.

61. The method of claim 43, wherein the authentication application is configured to generate a score based on the quality of match between the captured utterance and the reference voice information along with the unique identifier.

62. The method of claim 61, wherein the score that is generated determines the rules that control access to services.

63. The method of claim 62, wherein an individual who is issued a score below a threshold is restricted from at least one service.

64. The method of claim 62, wherein an individual who is issued a score above a threshold is transferred to a live operator or is otherwise granted access to a service.

65. The method of claim 62, wherein an individual who is issued a score below a threshold is required to provide additional corroborating information

66. The method of claim 65, wherein the corroborating information comprises confirmation of the individual's telephone number.

67. The method of claim 65, wherein the corroborating information comprises information obtained from additional challenges to the individual.

68. The method of claim 61, wherein an individual who is issued a score below a threshold and who is subsequently authenticated is required to re-enroll one or more forms of an utterance in the repository.

69. The method of claim 61, wherein the score is stored and used in subsequent processing of utterances associated with the individual.

70. The method of claim 61, wherein a suspicion level is assigned based on the score.

71. The method of claim 61, further comprising compiling a list of the names and captured utterances of suspicious individuals based on repeated issuances of scores below a threshold or failures to sufficiently corroborate information.

72. The method of claim 71, wherein the list along with the captured utterances are made available to consortium entities and third parties.

73. The method of claim 43, wherein an entity that offers access to reference voice information may charge a fee for providing such access for the purposes of validation or authentication, or for providing products and services related to the data.

74. A method of managing records associated with an individual, the records containing one or more forms of previously stored utterances in a repository of records contributed by multiple entities within a consortium to facilitate access to individual records enrolled in the repository by consortium members or third parties, the method comprising:
collecting secure and identifiable utterances associated with an individual from multiple contributing entities within the consortium;
storing one of more forms of the utterances as reference voice information in a repository;
retrieving and delivering one or more forms of reference voice information from the repository in response to authentication requests from consortium members or third parties; and
maintaining records stored in the repository associated with the individual by providing a secure interface that permits contributing entities within the consortium to enhance one or more forms of the stored utterances associated with the individual.

75. The method of claim 74, wherein access to the reference voice information is controlled by a manager of the repository.

76. The method of claim 75, wherein the manager administers at least one of: a directory or directories of records in the repository; access rules for the records; adaptation or evolution rules and security standards for the records; consortium members' compliance with the rules and standards; and delivery of the records for use, replication, or back-up.

77. The method of claim 75, wherein the manager offers access to the records on a transaction basis

78. The method of claim 75, wherein the manager offers access to the records concurrently with a transaction.

79. The method of claim 75, wherein the manager creates a back up repository containing replicas of stored reference utterances for redundancy purposes.

80. The method of claim 79, wherein modifications to a reference utterance in the repository are synchronized with a replica of the utterance in the back up repository.

81. The method of claim 75, wherein the manager charges a fee for providing management services.

82. The method of claim 75, wherein the manager charges a fee for providing access to the records containing the voice information for the purposes of enrollment, authentication, or for providing a product or service related to the data.

83. The method of claim 75, wherein the manager assigns access privileges to contributing entities, consortium members, and third parties that access records in the repository.

84. The method of claim 83, wherein an entity that contributes captured utterances or other biometric data is granted contributor privileges entitling the entity to enroll and enhance the utterances stored in the repository.

85. The method of claim 83, wherein an entity that does not contribute captured utterances or other biometric data to the repository is granted query privileges entitling the entity to submit authentication requests to retrieve one or more forms of stored utterances from the repository.

86. The method of claim 74, wherein the secure interface allows one or more forms of an individual's stored utterance to be enhanced by multiple contributing entities such that reference voice information in the repository is maintained as current.

87. The method of claim 74, wherein the secure interface allows any modification of the reference voice information in the repository to be shared between the consortium members.
